(19) United States
(12) Patent Application Publication
(10) Pub. No.: US 2010/0183033 A1
(43) Pub. Date: Jul. 22, 2010

(54) METHOD AND APPARATUS FOR ENCAPSULATION OF SCALABLE MEDIA

(75) Inventor: Miska Hannuksela, Ruutana (FI)

Correspondence Address: FOLEY & LARDNER LLP, P.O. BOX 80278, SAN DIEGO, CA, 92138-0278, US

(73) Assignee: Nokia Corporation

(21) Appl. No.: 12/356,497

(22) Filed: Jan. 20, 2009

(51) Int. Cl. H04L 29/04

(52) U.S. Cl. 370/476

(57) ABSTRACT

A method comprises forming a packet payload by encapsulating at least one data unit associated with media data; determining whether a size of the packet payload is less than a predetermined threshold; and if the size of the packet payload is less than the predetermined threshold, appending an enhancement data unit to the packet payload.

### FIELD OF INVENTION

The present invention relates generally to the field of real-time multimedia data and, more specifically, to improving quality of multimedia data in a packet-oriented network.

### BACKGROUND OF THE INVENTION

This section is intended to provide a background or context to the invention that is recited in the claims. The description herein may include concepts that may be pursued, but are not necessarily ones that have been previously conceived or pursued. Therefore, unless otherwise indicated herein, what is described in this section is not prior art to the description and claims in this application and is not admitted to be prior art by inclusion in this section.

In a packet-oriented network, there are at least two main sources of erasure errors. First, a transport decoder, or receiver, may discard an entire data packet due to one or more bit errors in the same data packet. Second, queue overflows in congested network elements, such as routers, usually cause packet losses.

A congestion, in one or more network elements, may be detected by a sending device based on a receiver feedback from a receiving device. Real time transport control protocol (RTCP) receiver reports and RTCP extended reports, also known as RTCP application (RTCP APP) packet with client buffer feedback, next application data unit application packet (NADU APP), are examples of receiver feedback. When congestion is detected, sending devices usually decrease the data transmission rate in order to avoid excessive network congestion and unfair network resource allocation. When a sender encodes video in real-time and there is only one receiver, a bitrate control algorithm of the encoder can be used for data rate adjustment. Otherwise, methods manipulating coded bitstreams, such as stream thinning and switching, may be used.

In many real-time applications, e.g., audio and/or video data streaming, there is a tradeoff between decoded media quality and network resources. Among the factors in achieving good decoded media quality is a sufficient data transmission rate, e.g., a high enough bitrate to achieve a high peak signal-to-noise ration (PSNR). However, the data transmission rate, in a communication network, is constrained by available bandwidth and/or other factors such as network congestion. Network congestion leads to loss of data packets, which usually leads to a degradation in decoded media data quality. Embodiments of the present invention are directed to methods and apparatus for adding quality enhancement data to scalable media, for transmission, without increasing the amount of packet losses in packet-switched networks.

### SUMMARY OF THE INVENTION

In one aspect of the invention, a method comprises forming a packet payload by encapsulating at least one data unit associated with media data; determining whether a size of the packet payload is less than a predetermined threshold; and if the size of the packet payload is less than the predetermined threshold, appending an enhancement data unit to the packet payload.

In one embodiment, the method further comprises repeating the determining of whether the packet payload size is less than the threshold and the appending of an enhancement data unit to the packet payload, if the packet payload size is less than the predetermined threshold, until the size of a resulting packet payload is equal to or greater than the predetermined threshold.

In one embodiment, forming the packet payload comprises encapsulating a first element based on at least one application data unit of a base quality representation into the packet payload.

In one embodiment, the appending of an enhancement data unit further comprises selecting an enhancement data unit to be appended to the packet payload. The selecting may comprise selecting the enhancement data unit based on at least one application data unit of an enhancement quality representation to be encapsulated into the packet payload, such that the size of the packet payload is smaller than the predetermined threshold.

In one embodiment, the media data comprises a first access unit and a second access unit, the first access unit comprising a first base quality representation and a first enhancement quality representation, the second access unit comprising a second base quality representation and a second enhancement quality representation. The at least one data unit may be at least one application data unit of one of the first and second base quality representation and the enhancement data unit may be at least one application data unit of the first and second enhancement quality representation. The packet payload may be transmitted responsive to an estimated network throughput being greater than a data rate required for transmitting the first base quality representation and the second base quality representation.

In one embodiment, the encapsulated at least one data unit comprises forward error correction repair data based on at least one application data unit of a base quality representation.

In one embodiment, the method further comprises transmitting the packet payload through a network. The transmitting may comprise estimating a network throughput. The estimating may comprise obtaining a transmission error rate; and if the transmission error rate is below an error rate threshold, transmitting the packet.

In one embodiment, encapsulation of the at least one data unit and the enhancement data unit is represented by instructions. The instructions may be stored in a file. The instructions may be constructors of a hint sample formatted according to the international organization for standardization (ISO) base media file format.

In another aspect of the invention, an apparatus comprises a memory unit and a processor communicatively connected to the memory unit. The processor is configured to form a packet payload by encapsulating at least one data unit associated with media data; determine whether a size of the packet payload is less than a predetermined threshold; and, if the size of the packet payload is less than the predetermined threshold, append an enhancement data unit to the packet payload.

In another aspect, a computer program product is embodied on a computer-readable medium and comprises computer code for forming a packet payload by encapsulating at least one data unit associated with media data; computer code for determining whether a size of the packet payload is less than a predetermined threshold; and computer code for, if the size of the packet payload is less than the predetermined threshold, appending an enhancement data unit to the packet payload.

These and other advantages and features of various embodiments of the present invention, together with the organization and manner of operation thereof, will become apparent from the following detailed description when taken in conjunction with the accompanying drawings.

### BRIEF DESCRIPTION OF THE DRAWINGS

Example embodiments of the invention are described by referring to the attached drawings, in which:

FIG. 1 is a flow chart illustrating a process in accordance with embodiments of the present invention;

FIG. 2 is an overview diagram of a system within which various embodiments of the present invention may be implemented;

FIG. 3 illustrates a perspective view of an exemplary electronic device which may be utilized in accordance with the various embodiments of the present invention;

FIG. 4 is a schematic representation of the circuitry which may be included in the electronic device of FIG. 3;

FIG. 5 is a graphical representation of a generic multimedia communication system within which various embodiments may be implemented;

FIG. 6 is a schematic illustration of an example file organized in accordance with an embodiment of the present invention and conforming to the ISO base media file format; and

FIG. 7 illustrates a simplified block diagram of an example device for encapsulation in accordance with embodiments of the present invention.

### DETAILED DESCRIPTION OF THE VARIOUS EMBODIMENTS

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions.

In a packet-oriented network, data packets may get lost due, for example, to network congestion. Data packets may also undergo different amounts of end-to-end delays, as they either get routed through different paths or as they are retransmitted according to a automatic retransmission protocols. Some applications, especially delay-constrained conversational applications, may regard delayed data packets as lost, because they miss their decoding or playback time.

Multimedia streaming applications, usually aim at providing good decoded media quality at a receiving, or decoding, device. An important factor, in improving decoded media quality, is the data transmission bitrate. An increase in bitrate, for example in multimedia streaming applications, usually leads to improvements in decoded media quality at the receiving device. Sending, or coding, devices, usually adjust data transmission bitrate, for example, according to perceived network throughput. For example, based on received feedback from a receiving device, a sending device may decide either to increase or decrease the transmission bitrate of an ongoing streaming session.

Increase in data transmission bitrate may be achieved, for example, by transmitting additional media packets. If some packets get lost due to router congestion, the decoded media quality may probably degrade even with the transmission of the additional media packets. In other words, an increase in the transmission rate of media packets may contribute to a congestion in a network element. As media packets may get lost during congestion, the transmission of additional media packets may not improve decoded media quality at the receiving device. In another example, forward error correcting (FEC) repair packets, instead of additional media packets, may be transmitted during a potential increase in network throughput. With the transmission of FEC repair packets, the decoded media quality is likely not to be affected even if the packet loss rate increases due to congestion. The FEC repair packets can be used to recover lost media packets. However, FEC repair packets usually do not improve decoded media quality, if media packets are not lost simply because FEC repair packets carry redundant data compared to the data carried in the media packets.

Packet losses in the Internet happen mainly due to queue overflows in routers. The size of individual packets, usually, does not contribute significantly in router queue overflows as long as the packet size is smaller than or equal to a maximum transfer unit (MTU) size. The data packet rate, however, is usually a more significant contributing factor to overflows in network elements.

It may not be possible to create packets whose size is close to, but does not exceed, MTU size at the time of encoding for several reasons. For example, most bit rate control algorithms calculate a target picture size in bytes based on the target bit rate for the bitstream. The target picture size in bytes might not be an integer multiple of the MTU size (or rather the maximum payload size). In this case, the packet containing the last slice of a picture is smaller than the MTU.

Further, coded pictures can be smaller than the MTU size especially when small picture size is used or when a picture appears high in the temporal scalability hierarchy. Also, the bit rate control algorithm might not produce slices of desired size. Finally, while usually the Ethernet MTU size (1500 bytes) can be assumed, the MTU size may not always be known at the time of encoding.

In accordance with embodiments of the present invention, quality enhancement data may be aggregated into data packets such that the packet size becomes close or equal to the MTU size. Consequently, the media quality is increased but the packet loss rate due to router congestion remains unchanged.

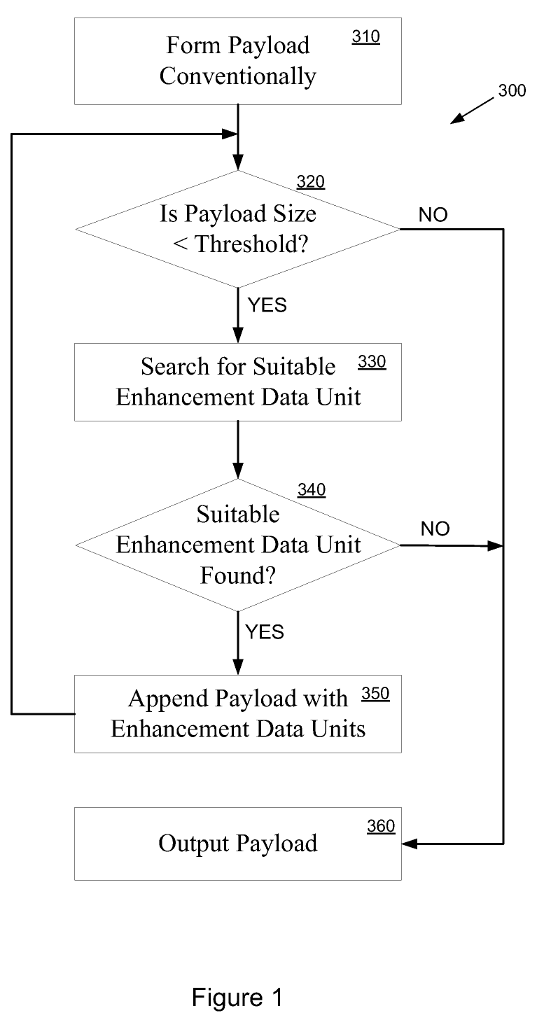

Referring now to FIG. 1, a process in accordance with embodiments of the present invention is illustrated. In accordance with the illustrated process 300, a packet payload may be formed conventionally (block 310). In this regard, any of several methods for forming a packet payload conventionally may be used. For example, a packet can contain a single application data unit, such as a Network Abstraction Layer (NAL) unit of scalable video coding (SVC) extension of the advanced video coding (H.264/AVC or SVC). In another example, a packet may contain as many base layer application data units of an access unit (or a frame) that fit into a packet whose size is smaller than or equal to the MTU size. In still another example, a packet may contain as many base layer application data units regardless of which access unit they belong to as long as the application data units are consecutive in decoding order within the base layer.

The size of the payload formed is compared to a threshold value (block 320). In accordance with embodiments of the present invention, the threshold value may be selected based on the MTU size and protocol headers. In the comparison at block 320, a determination is made as to whether the size of the payload is smaller than the threshold value.

If the determination is made at block 320 that the payload size is equal to or greater than the threshold value, the process 300 proceeds to block 360, and the payload is output from the encapsulator.

On the other hand, if the determination is made at block 320 that the payload size is less than the threshold value, a suitable enhancement data unit is searched at block 330. In accordance with embodiments of the present invention, the enhancement data unit may be based on the enhancement layer data of the media stream being encapsulated. In this regard, any of several methods may be used to select the enhancement data unit to be appended to the payload. Preferably, these methods should fulfill the following three requirements.

First, the selected enhancement data unit should be decodable. Thus, all the data units on which the selected enhancement data unit depends should (1) have been encapsulated into previous payload or in this payload or (2) will be encapsulated in this payload or subsequent payloads.

Second, the payload size resulting from appending the enhancement data unit into the payload should be smaller than or equal to the maximum size for the payload. Thus, the size of the resulting payload should be smaller than the threshold value.

Third, the receiver should be able to reorder the enhancement data unit that is appended into a correct decoding order of data units. The selected enhancement data unit may, but need not, follow in decoding order those data units that are encapsulated into the payload at block 310. If the appended enhancement data unit is not in decoding order within the payload, the receiver should buffer the packets and order the received data units into their decoding order. The buffering in the receiver may be controlled by parameters, such as those specified for the interleaved mode of H.264/AVC Real-Time Protocol (RTP) transmission. The appended enhancement data unit should be such that the packet stream meets the buffering constraints of the receiver. Additionally, in some embodiments, the bit rate of the transmitted packets may be limited, which may also limit the number (or size) of the enhancement data units that can be included in the payloads.

At block 340, a determination is made as to whether a suitable enhancement data unit has been found. If no suitable enhancement data unit meeting the requirements above is found in the search at block 330, the process 300 may proceed to block 360, and the payload may be output. On the other hand, if a suitable enhancement data unit is found, the payload is appended with the enhancement data unit at block 350, and the returns to block 320. Thus, the searching of a suitable enhancement data unit at block 330 and appending of the payload with the suitable enhancement data unit at block 350 may be repeated until suitable enhancement data unit is no longer found or the payload size is greater than or equal to the predetermined threshold value.

When appending the enhancement data unit into the payload, any aggregation mechanism available for the payload type can be used. For example, for the transport of SVC over RTP, single-time aggregation packets (STAPs) or multi-time aggregation packets (MTAPs) can be used.

The process 300 may be re-executed for payloads that have been output, because no suitable enhancement data unit meeting the requirements above was found earlier. It is possible that an enhancement data unit that had not been previously selected due to missing referenced data units can now be appended as those referenced data units have been later included in other payloads.

In accordance with embodiments of the present invention, any of several methods for selecting candidate enhancement data units to be appended to a payload may be used. In particular, when there are many scalability types, such as temporal, spatial, coarse grain quality scalability, and medium grain quality scalability, there can be different methods to estimate the subjective impact and consequently the preferred appending order of the enhancement data units.

One suitable method for prioritized video adaptation is described in I. Amonou, N. Cammas, S. Kervadec, and S. Pateux, “Optimized Rate-Distortion Extraction With Quality Layers in the Scalable Extension of H.264/AVC,” IEEE Transactions on Circuits and Systems for Video Technology, vol. 17. no. 9, pp. 1186-1193, September 2007.

Another method would be to select NAL units of MGS enhancement quality representations (quality_id>0) of the highest dependency representation to be appended to payloads in ascending temporal_id order. In other words, the available quality representations for pictures with temporal_id equal to 0 would be appended first. If there is still available space in the payloads, the available quality representations for pictures with temporal_id equal to 1 would be appended then, and so on.

The encoder can use the priority_id field of the NAL unit header of SVC bitstreams to indicate a preferred data priority order.

If the enhancement data units are Fine Granular Scalable, they can be truncated to match the available payload size exactly.

In many services, the amount of delay in the encoding and transmission does not affect the end-user experience, but the initial startup delay in the receiver can be a significant factor in the user experience. For example, the channel switching latency in television broadcasting is important for end-users.

In one embodiment of the present invention, the enhancement data units are transmitted earlier or at their correct decoding order with respect to the conventional packet payloads. Consequently, no initial buffering in the receiver is required for the reordering of the enhancement data units in their correct decoding order. All buffered enhancement data units follow, in decoding order, subsequently received base layer units, or are at their correct decoding position with respect to the base layer data units.

In one embodiment of the present invention, a payload can contain more than one stream or media type. The enhancement data unit can be selected among any of the multiplexed streams.

In one embodiment of the present invention, a payload is conventionally formed to include FEC repair data. Enhancement data units are appended in payloads containing FEC repair data.

When FEC repair data is used for probing whether the network throughput is increased, the packets according to embodiments of the invention not only have a neutral or positive impact on the residual packet loss rate but also provide media quality enhancement (over correctly decoded base layer media).

Various FEC algorithms and methods can be used with embodiments of the invention. As embodiments of the invention relates to transmission over IP networks, IETF standards for FEC for RTP streams are reviewed next. IETF RFC 2733 specifies an RTP payload format for XOR-based FEC protection. The payload header of FEC packets contains a bit mask identifying the packet payloads over which the bit-wise exclusive or (XOR) operation is calculated. One XOR FEC packet enables recovery of one lost source packet. IETF RFC 5109 replaced IETF RFC 2733 recently with a similar RTP payload format for XOR-based FEC protection also including the capability of uneven levels of protection. The payloads of the protected source packets are split into consecutive byte ranges starting from the beginning of the payload. The first byte range starting from the beginning of the packet corresponds to the strongest level of protection and the protection level decreases as a function of byte range order.

The packet size of repair packets according to RFC 2733 is (roughly) equal to the largest protected media packet. Hence, the potential room between the repair packets of RFC 2733 and the MTU size could be used for the enhancement data units according to embodiments of the invention. The payload size of the repair packets according to RFC 5109 match (roughly) the byte ranges of the uneven levels of protection. For example, if the greatest amount of protection is given to the first 100 bytes of the payload, the payload size of the repair packets is 100 bytes (plus the necessary payload headers). Again, the room between the payload size and the largest MTU payload size could be used for enhancement data units according to embodiments of the invention.

In one embodiment of the invention, the FEC repair data is derived not only from the conventionally formed payloads but also the enhancement data units appended to the payloads.

In one embodiment, FEC repair data based on enhancement data units are appended into payloads instead or in addition to the enhancement data units themselves.

In various embodiments of the invention, the MTU size is indicated to the encapsulator. The MTU size can be estimated based on expected connection types or protocols in the network. Alternatively, the MTU size can be signaled by the receiver (when it comes to the access link of the receiver) to the encapsulator. In addition, the MTU size can be signaled by any network element to the encapsulator. The sender or the gateway can signal the MTU size of the first access link to the encapsulator. The MTU size of different protocols within the protocol stack can be signaled. The exact size of the protocol headers or their size variation range (for the case of header compression) can be signaled similarly.

Thus, in accordance with embodiments of the present invention, the impact of packet losses in packet-oriented networks is reduced, and the received media quality is improved.

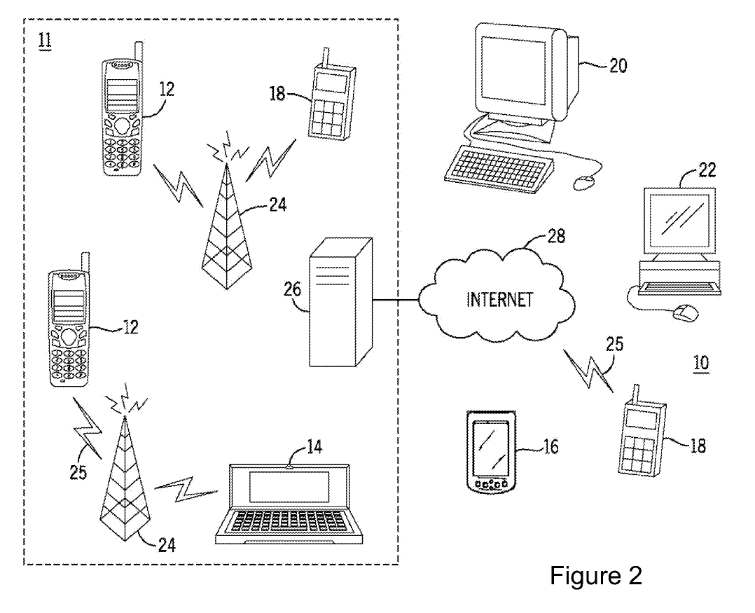

FIG. 2 shows a system 10 in which various embodiments of the present invention may be utilized, comprising multiple communication devices that may communicate through one or more networks. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 2 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The example communication devices of the system 10 may include, but are not limited to, an electronic device 12 in the form of a mobile telephone, a combination personal digital assistant (PDA) and mobile telephone 14, a PDA 16, an integrated messaging device (IMD) 18, a desktop computer 20, a notebook computer 22, etc. The communication devices may be stationary or mobile as when carried by an individual who is moving. The communication devices may also be located in a mode of transportation including, but not limited to, an automobile, a truck, a taxi, a bus, a train, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments of the present invention may communicate using various media including, but not limited to, radio, infrared, laser, cable connection, and the like.

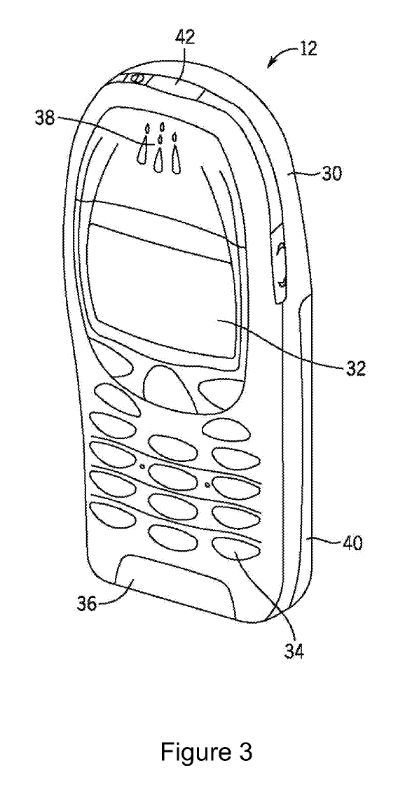

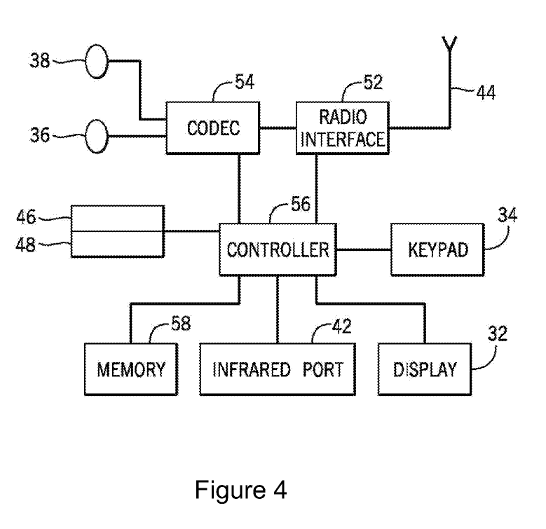

FIGS. 3 and 4 show one representative electronic device 28 which may be used as a network node in accordance to the various embodiments of the present invention. It should be understood, however, that the scope of the present invention is not intended to be limited to one particular type of device. The electronic device 28 of FIGS. 3 and 4 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58. The above described components enable the electronic device 28 to send/receive various messages to/from other devices that may reside on a network in accordance with the various embodiments of the present invention. Individual circuits and elements are all of a type well known in the art, for example in the Nokia range of mobile telephones.

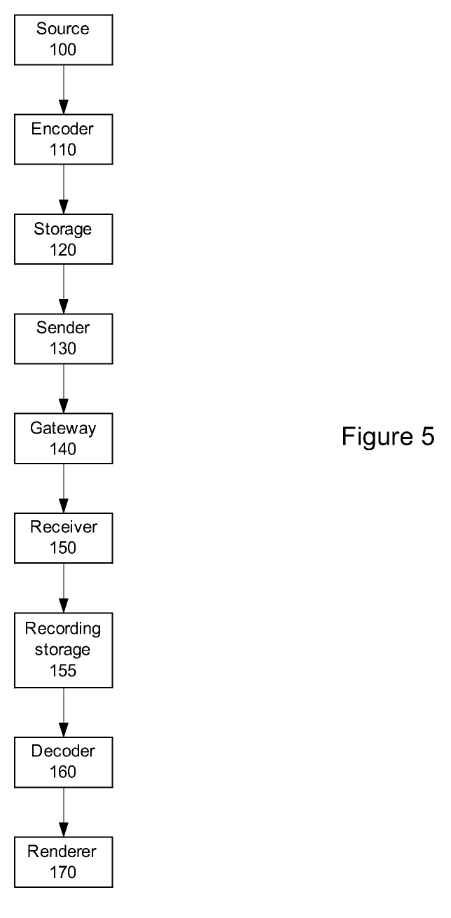

FIG. 5 is a graphical representation of a generic multimedia communication system within which various embodiments of the present invention may be implemented. As shown in FIG. 5, a data source 100 provides a source signal in an analog, uncompressed digital, or compressed digital format, or any combination of these formats. An encoder 110 encodes the source signal into a coded media bitstream. It should be noted that a bitstream to be decoded may be received directly or indirectly from a remote device located within virtually any type of network. Additionally, the bitstream may be received from local hardware or software. The encoder 110 may be capable of encoding more than one media type, such as audio and video, or more than one encoder 110 may be required to code different media types of the source signal. The encoder 110 may also get synthetically produced input, such as graphics and text, or it may be capable of producing coded bitstreams of synthetic media. In the following, only processing of one coded media bitstream of one media type is considered to simplify the description. It should be noted, however, that typically real-time broadcast services comprise several streams (typically at least one audio, video and text sub-titling stream). It should also be noted that the system may include many encoders, but in FIG. 5 only one encoder 110 is represented to simplify the description without a lack of generality. It should be further understood that, although text and examples contained herein may specifically describe an encoding process, one skilled in the art would understand that the same concepts and principles also apply to the corresponding decoding process and vice versa.

The coded media bitstream is transferred to a storage 120. The storage 120 may comprise any type of mass memory to store the coded media bitstream. The format of the coded media bitstream in the storage 120 may be an elementary self-contained bitstream format, or one or more coded media bitstreams may be encapsulated into a container file. If one or more media bitstreams are encapsulated in a container file, a file generator (not shown in the figure) is used to store the one more more media bitstreams in the file and create file format metadata, which is also stored in the file. The encoder 110 or the storage 120 may comprise the file generator, or the file generator is operationally attached to either the encoder 110 or the storage 120. Some systems operate “live”, i.e. omit storage and transfer coded media bitstream from the encoder 110 directly to the sender 130. The coded media bitstream is then transferred to the sender 130, also referred to as the server, on a need basis. The format used in the transmission may be an elementary self-contained bitstream format, a packet stream format, or one or more coded media bitstreams may be encapsulated into a container file. The encoder 110, the storage 120, and the server 130 may reside in the same physical device or they may be included in separate devices. The encoder 110 and server 130 may operate with live real-time content, in which case the coded media bitstream is typically not stored permanently, but rather buffered for small periods of time in the content encoder 110 and/or in the server 130 to smooth out variations in processing delay, transfer delay, and coded media bitrate.

The server 130 sends the coded media bitstream using a communication protocol stack. The stack may include but is not limited to Real-Time Transport Protocol (RTP), User Datagram Protocol (UDP), and Internet Protocol (IP). When the communication protocol stack is packet-oriented, the server 130 encapsulates the coded media bitstream into packets. For example, when RTP is used, the server 130 encapsulates the coded media bitstream into RTP packets according to an RTP payload format. Typically, each media type has a dedicated RTP payload format. It should be again noted that a system may contain more than one server 130, but for the sake of simplicity, the following description only considers one server 130.

If the media content is encapsulated in a container file for the storage 120 or for inputting the data to the sender 130, the sender 130 may comprise or be operationally attached to a “sending file parser” (not shown in the figure). In particular, if the container file is not transmitted as such but at least one of the contained coded media bitstream is encapsulated for transport over a communication protocol, a sending file parser locates appropriate parts of the coded media bitstream to be conveyed over the communication protocol. The sending file parser may also help in creating the correct format for the communication protocol, such as packet headers and payloads. The multimedia container file may contain encapsulation instructions, such as hint tracks in the ISO Base Media File Format, for encapsulation of the at least one of the contained media bitstream on the communication protocol

The server 130 may or may not be connected to a gateway 140 through a communication network. The gateway 140 may perform different types of functions, such as translation of a packet stream according to one communication protocol stack to another communication protocol stack, merging and forking of data streams, and manipulation of data stream according to the downlink and/or receiver capabilities, such as controlling the bit rate of the forwarded stream according to prevailing downlink network conditions. Examples of gateways 140 include multipoint conference control units (MCUs), gateways between circuit-switched and packet-switched video telephony, Push-to-talk over Cellular (PoC) servers, IP encapsulators in digital video broadcasting-handheld (DVB-H) systems, or set-top boxes that forward broadcast transmissions locally to home wireless networks. When RTP is used, the gateway 140 is called an RTP mixer or an RTP translator and typically acts as an endpoint of an RTP connection.

The system includes one or more receivers 150, typically capable of receiving, de-modulating, and de-capsulating the transmitted signal into a coded media bitstream. The coded media bitstream is transferred to a recording storage 155. The recording storage 155 may comprise any type of mass memory to store the coded media bitstream. The recording storage 155 may alternatively or additively comprise computation memory, such as random access memory. The format of the coded media bitstream in the recording storage 155 may be an elementary self-contained bitstream format, or one or more coded media bitstreams may be encapsulated into a container file. If there are many coded media bitstreams, such as an audio stream and a video stream, associated with each other, a container file is typically used and the receiver 150 comprises or is attached to a receiving file generator (not shown in the figure) producing a container file from input streams. Some systems operate “live,” i.e. omit the recording storage 155 and transfer coded media bitstream from the receiver 150 directly to the decoder 160. In some systems, only the most recent part of the recorded stream, e.g., the most recent 10-minute excerption of the recorded stream, is maintained in the recording storage 155, while any earlier recorded data is discarded from the recording storage 155.

The coded media bitstream is transferred from the recording storage 155 to the decoder 160. If there are many coded media bitstreams, such as an audio stream and a video stream, associated with each other and encapsulated into a container file or a single media bitstream is encapsulated in a container file e.g. for easier access, a file parser (not shown in the figure) is used to decapsulate each coded media bitstream from the container file. The recording storage 155 or a decoder 160 may comprise the file parser, or the file parser is attached to either recording storage 155 or the decoder 160.

The codec media bitstream is typically processed further by a decoder 160, whose output is one or more uncompressed media streams. Finally, a renderer 170 may reproduce the uncompressed media streams with a loudspeaker or a display, for example. The receiver 150, recording storage 155, decoder 160, and renderer 170 may reside in the same physical device or they may be included in separate devices.

An encapsulator as described above with reference to FIG. 1 may be present in various elements of the generic multimedia communication system illustrated in FIG. 5.

The encapsulator may also be present in the encoder 110 or the sender 130, and the storage 120 may not be present, i.e., the encoder and the sender may operate “live”. In this case, a simple bit rate control algorithm can be used in the encoder and the encapsulator can control the packet sizes based on the MTU size and the transmission bit rate.

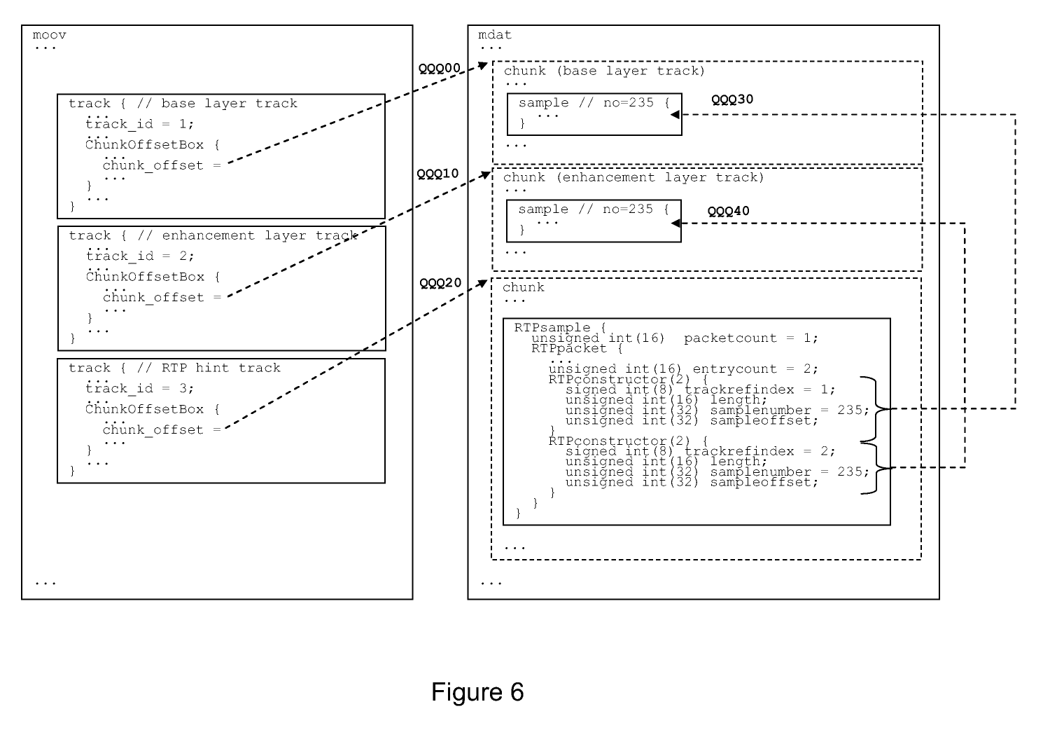

When files in the storage 120 are formatted to include packetization hints, such as those according to the hint tracks of the ISO base media file format, the encapsulator can be present in the encoder 110 or the file generator. FIG. 6 presents a simplified schematic example of a file organized according to an embodiment of the invention and conforming to the ISO base media file format. The movie box of the file contains descriptions of three tracks: a base layer video track, an enhancement layer representation video track, and an RTP hint track. Among other things, tracks are characterized by a track_id value, given in the track header. Each track box also contains a chunk offset box, which indicates the location of sample data within the referenced file (usually within the mdat box of the file). Three chunks, one per each track, are illustrated in the example. A chunk contains samples of the respective track (and does not contain any data for other tracks). A sample of both of the video tracks represents a valid access unit (e.g. according to the SVC standard). A sample of the RTP hint track represents one RTP packet in this example. An RTP hint sample contains a representation of many fields of the RTP packet header and one or more constructors according to which the payload of the packet is constructed. The RTP hint sample presented in the example contains two constructors, one for base layer data and another one for enhancement layer data. Both constructors indicate the track to which they refer (through the track_id value), the sample number of the referred track, the offset within the sample of the referred track, and the number of bytes (length) of data to copy into the packet payload. An RTP hint sample that is formed according to embodiments of the invention includes one or more constructors for forming a packet payload associated with media data and, provided that the size of the packet payload is less than a predetermined threshold, one or more constructors for appending enhancement layer data into the packet payload. In the example, the payload size resulting from the first constructor of the sample is smaller than a predetermined threshold, and enhancement layer data is appended into the packet payload by the second constructor.

The encapsulator may also be present in the gateway 140.

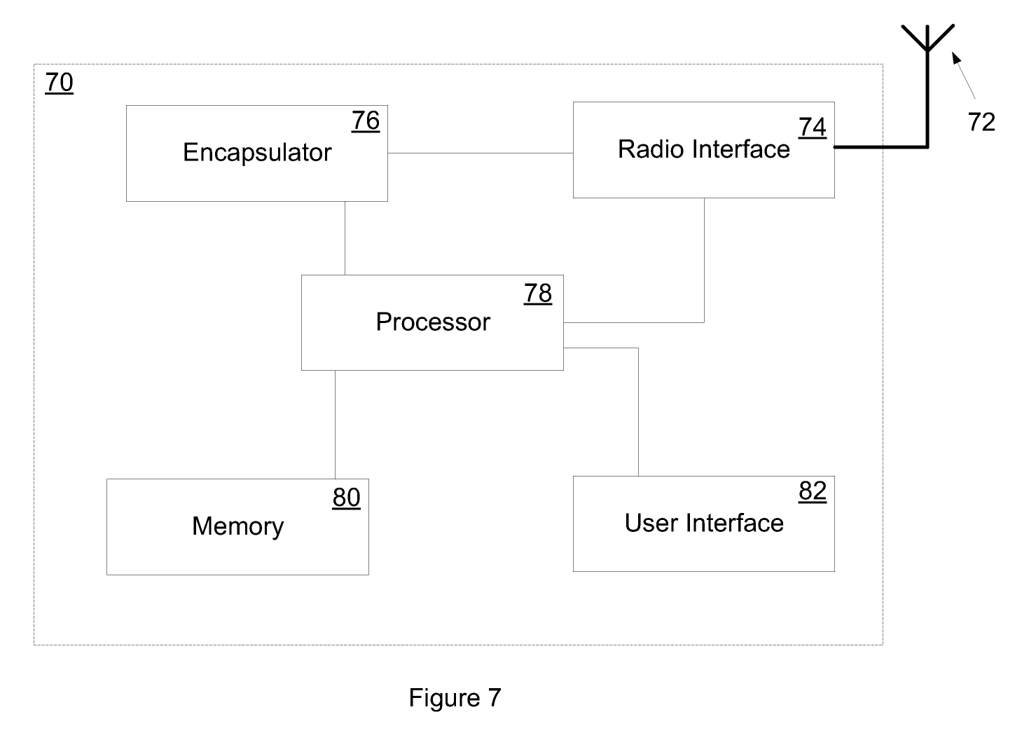

FIG. 7 illustrates a simplified block diagram of an example device 70 for encapsulation in accordance with embodiments of the present invention. The device 70 may be a server, a handheld device or other such communcation device. In the illustrated embodiment, the device 70 is configured for wireless communication and, in this regard, includes an antenna 72 adapted to receive and transmit signals for communication. As with the electronic device 12 described above with reference to FIGS. 2 and 3, the antenna 72 and a radio interface module 74 of the device 70 may be tuned for communication at one or more ranges of frequencies.

An encapsulator module 76 is coupled to the radio interface module 74. The encapsulator module 76 may be cofigured to encapsulate the packet payloads as described above with reference to FIG. 1, for example.

The encapsulator module 76 and the radio interface module 74 may be coupled to a processor 78 configured to control the operation of the device 70. In this regard, the processor 78 may be a central processing unit. In various embodiments, the functions of the encapsulator module 76 and the processor 78 may be merged into a single module. For example, the processor may be configured to perfrom the encapsulation in accordance with FIG. 1.

A memory module 80 may be provided to store data and programs to be accessed by the processor 78 and the encoder module 76. In order to facilitate interaction with a user of the device 70, a user interface 82 may be provided. The user interface 82 may include a keyboard, a touch screen or other input device. The user interface 82 may also include an output device, such as a screen.

Various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Embodiments of the present invention may be implemented in software, hardware, application logic or a combination of software, hardware and application logic. The software, application logic and/or hardware may reside, for example, on a chipset, a mobile device, a desktop, a laptop or a server. Software and web implementations of various embodiments may be accomplished with standard programming techniques with rule-based logic and other logic to accomplish various database searching steps or processes, correlation steps or processes, comparison steps or processes and decision steps or processes. Various embodiments may also be fully or partially implemented within network elements or modules. It should be noted that the words “component” and “module,” as used herein and in the following claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method, comprising:
forming a packet payload by encapsulating at least one data unit associated with media data;
determining whether a size of the packet payload is less than a predetermined threshold; and
if the size of the packet payload is less than the predetermined threshold, appending an enhancement data unit to the packet payload.

2. The method of claim 1, further comprising:
repeating said determining whether the size is less than the threshold and said appending an enhancement data unit to the packet payload, if the size of the packet payload is less than the predetermined threshold, until the size of a resulting packet payload is equal to or greater than the predetermined threshold.

3. The method of claim 1, wherein said forming a packet payload comprises encapsulating a first element based on at least one application data unit of a base quality representation into the packet payload.

4. The method of claim 1, wherein said appending further comprises:
selecting an enhancement data unit to be appended to the packet payload.

5. The method of claim 4, wherein the selecting comprises:
selecting the enhancement data unit based on at least one application data unit of an enhancement quality representation to be encapsulated into the packet payload, such that the size of the packet payload is smaller than the predetermined threshold.

6. The method of claim 1, wherein the media data comprises a first access unit and a second access unit, the first access unit comprising a first base quality representation and a first enhancement quality representation, the second access unit comprising a second base quality representation and a second enhancement quality representation.

7. The method of claim 6, wherein the at least one data unit is at least one application data unit of one of the first and second base quality representation and the enhancement data unit is at least one application data unit of the first and second enhancement quality representation.

8. The method of claim 6, wherein the packet payload is transmitted in response to an estimated network throughput being greater than a data rate required for transmitting the first base quality representation and the second base quality representation.

9. The method of claim 1, wherein the at least one data unit comprises forward error correction repair data based on at least one application data unit of a base quality representation.

10. The method of claim 1, further comprising:
obtaining a transmission error rate; and
if the transmission error rate is below an error rate threshold, transmitting the packet payload.

11. The method of claim 1, wherein encapsulation of the at least one data unit and the enhancement data unit is represented by instructions.

12. The method of claim 11, wherein the instructions are stored in a file.

13. The method of claim 11, wherein the instructions are constructors of a hint sample formatted according to the international organization for standardization (ISO) base media file format.

14. An apparatus, comprising:
a memory unit; and
a processor communicatively connected to the memory unit, said processor being configured to:
form a packet payload by encapsulating at least one data unit associated with media data;
determine whether a size of the packet payload is less than a predetermined threshold; and
if the size of the packet payload is less than the predetermined threshold, append an enhancement data unit to the packet payload.

15. The apparatus of claim 14, wherein the processor is further configured to:
repeat determining whether the size is less than the threshold and appending an enhancement data unit to the packet payload, if the size of the packet payload is less than the predetermined threshold, until the size of a resulting packet payload is equal to or greater than the predetermined threshold.

16. The apparatus of claim 14, wherein the processor is further configured to:
select an enhancement data unit to be appended to the packet payload.

17. The apparatus of claim 14, wherein the media data comprises a first access unit and a second access unit, the first access unit comprising a first base quality representation and a first enhancement quality representation, the second access unit comprising a second base quality representation and a second enhancement quality representation.

18. The apparatus of claim 17, wherein the at least one data unit is at least one application data unit of one of the first and second base quality representation and the enhancement data unit is at least one application data unit of the first and second enhancement quality representation.

19. The apparatus of claim 17, wherein the processor is further configured to transmit the packet payload in response to an estimated network throughput being greater than a data rate required for transmitting the first base quality representation and the second base quality representation.

20. The apparatus of claim 14, wherein the at least one data unit comprises forward error correction repair data based on at least one application data unit of a base quality representation.

21. The apparatus of claim 14, wherein the processor is further configured to:
obtain a transmission error rate; and
if the transmission error rate is below an error rate threshold, transmit the packet payload.

22. The apparatus of claim 14, wherein the memory unit is configured to store instructions for encapsulating the at least one data unit and the enhancement data unit.

23. A computer program product, embodied on a computer-readable medium, said computer program product comprising:
computer code for forming a packet payload by encapsulating at least one data unit associated with media data;
computer code for determining whether a size of the packet payload is less than a predetermined threshold; and
computer code for, if the size of the packet payload is less than the predetermined threshold, appending an enhancement data unit to the packet payload.

24. The computer program product of claim 23, further comprising:
computer code for repeating determining whether the size is less than the threshold and appending an enhancement data unit to the packet payload, if the size of the packet payload is less than the predetermined threshold, until the size of a resulting packet payload is equal to or greater than the predetermined threshold.
